(19) United States
(12) Patent Application Publication
(10) Pub. No.: US 2024/0302308 A1
(43) Pub. Date: Sep. 12, 2024

(54) SYSTEM AND METHOD OF AN IN-SITU CALIBRATION OF A CHEMIRESISTOR SENSOR

(71) Applicant: NANOSCENT LTD., Misghav (IL)

(72) Inventors: Sima Simha ISRAEL, Atsmon Segev (IL); Roie SHLOMOVITZ, Kiryat Tivon (IL); Eran ROM, Yaad (IL)

(73) Assignee: NANOSCENT LTD., Misghav (IL)

(21) Appl. No.: 18/596,973

(22) Filed: Mar. 6, 2024

Related U.S. Application Data
(60) Provisional application No. 63/450,114, filed on Mar. 6, 2023.

(51) Int. Cl. G01N 27/12; G01N 27/04

(52) U.S. Cl. CPC G01N 27/123; G01N 27/045

(57) ABSTRACT

A method of an in-situ calibration of a chemiresistor sensor is disclosed. The method comprising: heating and/or cooling at least one chemiresistor sensor in a ΔT° C., wherein the at least one chemiresistor sensor is assembled in a sensing device; receiving a first temperature signal indicative of temperature measurement from a temperature sensor located in the sensing device to the chemiresistor sensor; receiving a first signal from the chemiresistor sensor, and determining a mathematical correlation between the first temperature signal and the first signal. In some embodiments, the heating and/or cooling induces changes in the signal indicative of temperature measurement and the signal received from the chemiresistor sensor.

### CROSS REFERENCE TO RELATED APPLICATIONS

This application claims the benefit of priority under 35 U.S.C. § 119(e) of U.S. Provisional Patent Application No. 63/450,114, filed 6 Mar. 2023, entitled “SYSTEM AND METHOD OF AN IN-SITU CALIBRATION OF A CHEMIRESISTOR SENSOR”. The contents of the above application is all incorporated by reference as if fully set forth herein in its entirety.

### FIELD OF THE INVENTION

The present invention relates generally to methods of calibration of a chemiresistor sensor. More specifically, the present invention relates to a system and a method of an in-situ calibration of a chemiresistor sensor.

### BACKGROUND OF THE INVENTION

Chemiresistor sensors are sensors that can detect the presence of an analyte. A chemiresistor sensor includes a material or structure that changes its electrical resistance in response to changes in the nearby chemical environment, for example, due to the presence of analytes. Commercial chemiresistor sensors for sensing analytes include a sensing element made from one of: carbon nanotubes, graphene, carbon nanoparticles, conductive polymers and the like. These chemiresistor sensors are sensitive to cleaning and regeneration cycles which are required after each measurement, due to the nonuniformity nature of the sensor's material. Another optional sensor includes metallic nanoparticles cores coated with organic ligands. The organic ligands are bonded with the surface of the metallic core at one end and are configured to be weakly bonded (e.g., interact) to a analyte at the other end. The most suitable and widely used cores are nanoparticles of: Au, Pt, Pd Ag and further also alloys consisting of Ni, Co, Cu, Al, Au/Ag, Au/Cu, Au/Ag/Cu, Au/Pt, Au/Pd, Au/Ag/Cu/Pd, Pt/Rh, Ni/Co, and Pt/Ni/Fe.

The most common type of organic ligands that can form a bond with the surface of a metallic particle having one of the above listed metallic cores are thiols (sulfides). Exemplary thiols that can be bonded with the metallic cores include alkylthiols with C3-C24 chains, co-functionalized alkanethiolates, arenethiolate, (3-mercaptopropyl) tri-methyloxysilane, dialkyl disulfides, xanthates, oligonucleotides, polynucleotides, peptides, proteins, enzymes, polysaccharides, and phospholipids. These thiols form relatively stable bonds in comparison with other organic ligands, however they are not stable enough and undergo dissociation over time.

The accuracy of the measurements, and more specifically repeated measurements requires taking all measurements under similar conditions, for example, similar temperature and humidity. As similar conditions can only be formed in laboratory conditions, deviation in measurements due to deviation in temperatures must be taken into account.

Accordingly, there is a need for a method and a device that may allow correcting measurements taken by a chemiresistor sensor in situ, at every location. The method may allow receiving accurate sensing independent of the temperature surrounding the chemiresistor sensor.

### SUMMARY OF THE INVENTION

Some aspects of the invention may be directed to a method of an in-situ calibration of a chemiresistor sensor, comprising: heating and/or cooling at least one chemiresistor sensor in a ΔT° C., wherein the at least one chemiresistor sensor is assembled in a sensing device; receiving a first temperature signal indicative of temperature measurement from a temperature sensor located in the sensing device to the chemiresistor sensor; receiving a first signal from the chemiresistor sensor; and determining a mathematical correlation between the first temperature signal and the first signal. In some embodiments, the heating and/or cooling induces changes in the signal indicative of temperature measurement and the signal received from the chemiresistor sensor.

In some embodiments, during the heating and cooling, the chemiresistor sensor is exposed to a known environment. In some embodiments, the method further comprising: exposing the chemiresistor sensor to a target analyte source; receiving a second temperature signal indicative of temperature measurement from the temperature sensor; receiving a second signal from the chemiresistor sensor; and correcting the second signal using the second temperature signal and the mathematical correlation.

In some embodiments, the mathematical correlation is selected from, a linear correlation, a polynomial correlation, and an exponential correlation. In some embodiments, the temperature sensor is selected from: a conductive wire attached to the chemiresistor sensor, a thermocouple attached to the chemiresistor sensor, and a thermometer located anywhere inside the sensing device.

In some embodiments, the first signal is one of, a resistance of the chemiresistor sensor, a capacity of the chemiresistor sensor, a conductivity of the chemiresistor sensor, impedance and inductance of the chemiresistor sensor. In some embodiments, the known environment comprising one of: a vacuum of at least 0.7 atm, at least 99% N₂, at least 99% He, at least 99% H₂, at least 99% Ar, and a known concentration of a known analyte.

In some embodiments, the heating and/or cooling is conducted from a predetermined base temperature.

Some additional aspects of the invention are directed to a sensing system with an in-situ temperature calibration, comprising: a sensing device comprising: a sensing chamber; a sample delivery system configured to deliver an analyte sample into the sensing chamber; a chemiresistor sensor located inside the sensing chamber; and a temperature sensor located inside the sensing device; and a controller configured to: heat and/or cool the chemiresistor sensor to a ΔT° C.; receive a first signal indicative of temperature measurement from the temperature sensor; receive a first signal from the chemiresistor sensor; and determine a mathematical correlation between the signal indicative of temperature measurement and the signal. In some embodiments, the heating and/or cooling induces changes in the signal indicative of temperature measurement and the signal received from the chemiresistor sensor.

In some embodiments, during the heating and cooling, the chemiresistor sensor is exposed to a known environment. In some embodiments, the controller is further configured to: expose the chemiresistor sensor to a target analyte source; receive a second signal indicative of temperature measurement from the temperature sensor; receive a second signal from the chemiresistor sensor; and correct the second signal using the second signal indicative of temperature measurement and the mathematical correlation.

In some embodiments, the mathematical correlation is selected from, a linear correlation, a polynomial correlation, and an exponential correlation. In some embodiments, the temperature sensor is selected from a conductive wire attached to the chemiresistor sensor, a thermocouple attached to the chemiresistor sensor, and a thermometer located anywhere inside the sensing device. In some embodiments, the first signal is one of, a resistance of the chemiresistor sensor, a capacity of the chemiresistor sensor, a conductivity of the chemiresistor sensor, impedance and inductance of the chemiresistor sensor. In some embodiments, the known environment comprising one of: vacuum of at least 0.7 atm, at least 99% N₂, at least 99% He, at least 99% H₂, at least 99% Ar, and a known concentration of a known analyte. In some embodiments, the heating and/or cooling is conducted from a predetermined base temperature.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a block diagram of a sensing system with an in-situ temperature calibration according to some embodiments of the invention;

FIG. 1B is a block diagram, depicting a computing device which may be included in a sensing system with an in-situ temperature calibration according to some embodiments of the invention;

FIG. 2A is an illustration of a chemiresistor sensor according to some embodiments of the invention;

FIG. 2B is an illustration of a particle for a chemiresistor sensor according to some embodiments of the invention;

FIG. 3A is a flowchart of a method of an in-situ calibration of a chemiresistor sensor according to some embodiments of the invention;

FIG. 3B is a flowchart of a method of correcting sensing measurements using a calibration correlation determined by the method of FIG. 3A according to some embodiments of the invention;

FIG. 4A is a graph showing a linear correlation between a temperature signal and a chemiresistor sensor signal according to some embodiments of the invention;

FIG. 4B is an illustration of an electrical circuit of the system according to some embodiments of the invention;

FIGS. 4C and 4D show graphs of time-dependent measurements of the temperature sensor and the chemiresistor sensor during a calibration period when the sensor is exposed to an analyte according to some embodiments of the invention;

FIGS. 5A, 5B, and 5C. FIG. 5A shows a raw second signal as received from the chemiresistor sensor and a corrected signal after being corrected using a linear metamathematical correlation according to some embodiments of the invention; and

FIG. 6 is a graph showing a calibration process between resistance measurements of a wire and temperature measurements from a thermometer according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention disclose a method of an in-situ calibration of a chemiresistor sensor in a sensing system. Such a sensing system may allow receiving measurements (e.g., resistance) from the chemiresistor sensor which are independent of the temperature in the surrounding of the chemiresistor sensor.

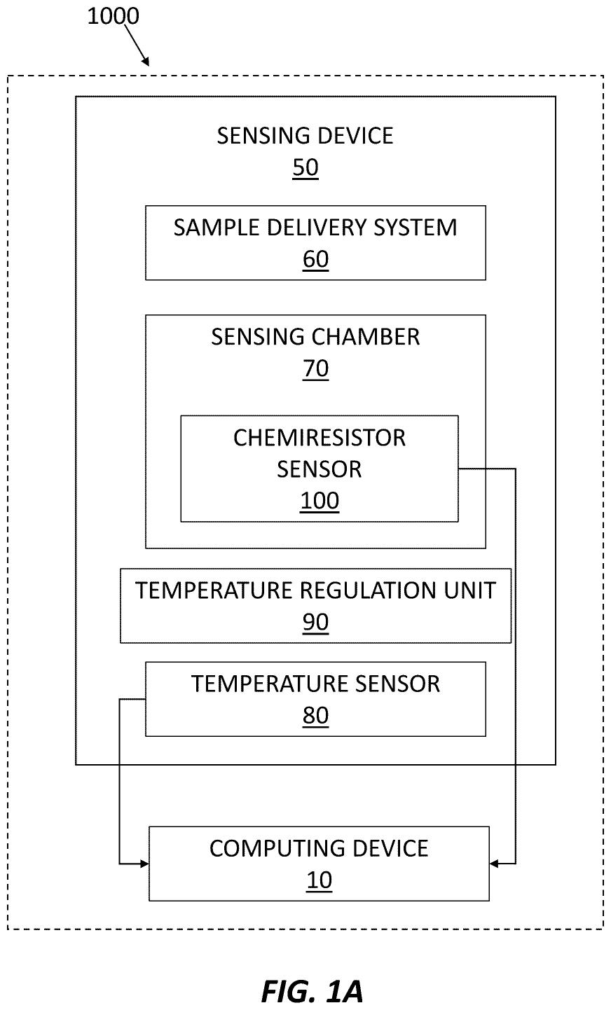

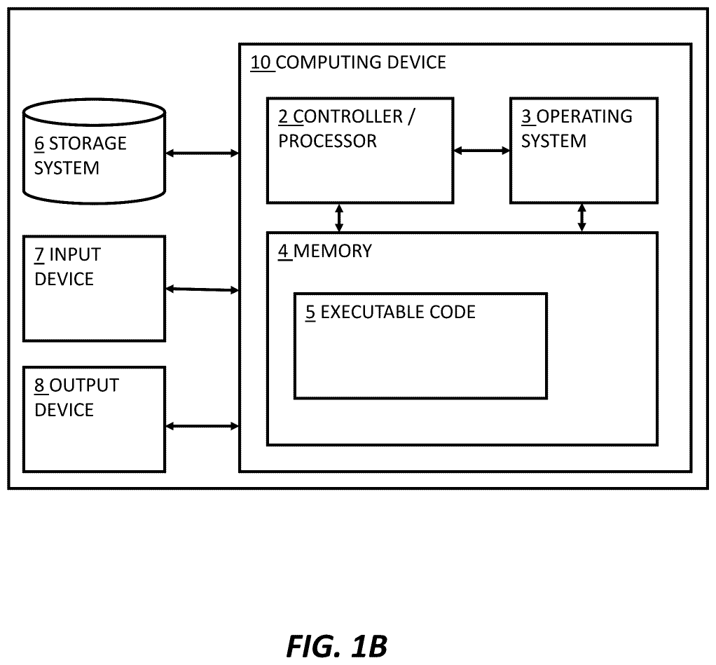

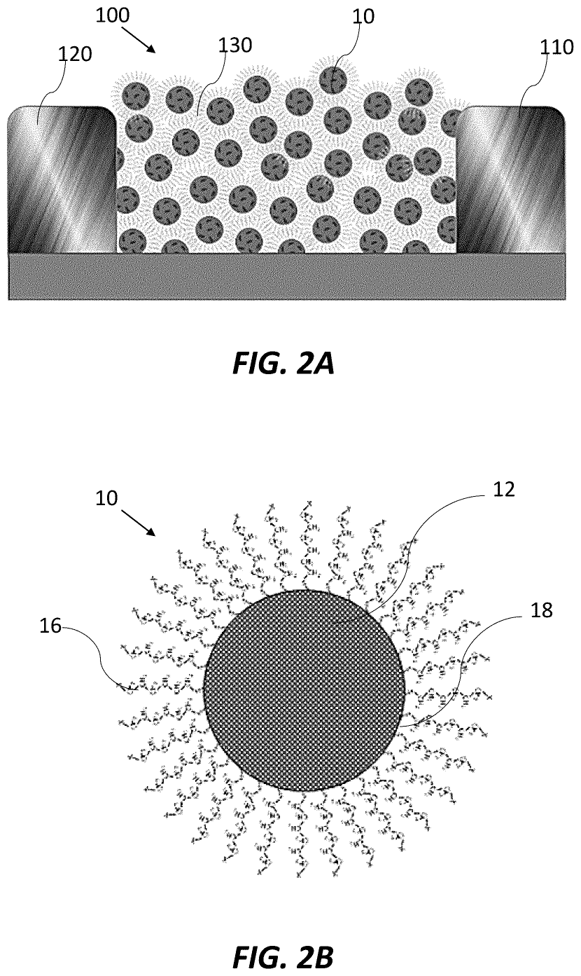

Reference is now made to FIG. 1A which is a block diagram of a sensing system with an in-situ temperature calibration according to some embodiments of the invention. A sensing system 1000 according to embodiments of the invention may include a sensing device 50 comprising, a sample delivery system 60, a sensing chamber 70, and one or more chemiresistor sensors 100 located inside sensing chamber 50. The structure of chemiresistor sensor 100 is discussed in detail with respect to FIGS. 2A and 2B hereinbelow.

The sample sensing chamber 70 may be configured to hold the analyte in the gas phase while exposing one or more chemiresistor sensors 100 of the analyte or a known environment. As used herein a known environment may include any chemically known composition of gases and analytes, for example, a vacuum of at least 0.7 atm, at least 99% N₂, at least 99% He, at least 99% H₂, at least 99% Ar, a known concentration of a known analyte, and the like. In some embodiments, one or more chemiresistor sensors 100 may be assembled/printed on a Printed Circuit Board (PCB) that may further include a local processor and a communication unit, configured to send signals from one or more chemiresistor sensors 100 to a computing device 10.

In some embodiments, sample delivery system 60 is configured to deliver the analyte that can be a volatile compound (VC) sample/inert gas or a liquid sample, into sensing chamber 70 and direct the sample towards one or more chemiresistor sensors 100. Sample delivery system 60 may include at least one of pipes, a fan, a pump, one or more gas monitoring sensors, one or more valves, at least one filter, a manifold, and the like.

In some embodiment, sensing device 50 may further include a temperature sensor 80 located inside sensing device 50. In some embodiments, temperature sensor 80 may measure the temperature of at least one of, one or more chemiresistor sensors 100, the sample, the gases inside sensing chamber 70, and the like. In some embodiments, temperature sensor 80 is selected from: a conductive wire attached to the PCB carrying one or more chemiresistor sensors, a thermocouple attached to one or more chemiresistor sensors 100 or to the PCB carrying one or more chemiresistor sensors 100, and a thermometer located anywhere inside sensing device 50, for example, attached to a wall of sensing chamber 70, placed in a pipe of sample delivery system 60 and the like.

Sensing system 1000 may further include a temperature regulation unit 90 for controllably heating and/or cooling at least one of, one or more chemiresistor sensors 100, the sample, sensing chamber 70, and the like. Temperature regulation unit 90 may include any component that can controllably heat and/or cool a sample or a component of device 50. For example, temperature regulation unit 90 may include, heating elements (e.g., coils), hot air/cool air blowers, cooling tunnels/pipes, heatsinks, and the like.

In some embodiments, temperature regulation unit 90 may be located inside sensing chamber 70, as illustrated, and may be configured to directly heat one or more chemiresistor sensors 100 and temperature sensor 80, when sensor 80 is located inside chamber 70 (e.g., when both sensor 80 add temperature regulation unit 90 are attached to a PCB carrying one or more chemiresistor sensors 100. In some embodiments, temperature regulation unit 90 may be located elsewhere in device 50 or external to device 50, for example, when configured to heat gasses entering sensing device 50.

Sensing system 1000 may further include a computing device 10 discussed in detail with respect to FIG. 1B.

Reference is now made to FIG. 1B, which is a block diagram depicting a computing device, which may be included within an embodiment of a sensing system with an in-situ temperature calibration, according to some embodiments.

Computing device 10 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 10 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 10, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task or script. Executable code 5 may be executed by processor or controller 2 possibly under control of operating system 3. For example, executable code 5 may be an application that may in-situ calibrate of a chemiresistor sensor as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Mathematical correlation to be used for calibrating the sensing system may be stored in storage system 6 and may be loaded from storage system 6 into memory 4 where it may be processed by processor or controller 2. In some embodiments, some of the components shown in FIG. 1B may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 10 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 10 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

Reference is now made to FIG. 2A which is an illustration of a chemiresistor sensor according to some embodiments of the invention. A chemiresistor sensor 100 may include: two electrodes 110 and 120 and a sensing element 130 connected to electrodes 110 and 120 and comprising a structure made from the particles 10 discloses herein below. Chemiresistor sensor 100 may be included in a sensing device 50. Electrodes 110 and 120 may be connected to a processor (e.g., a chip) that may detect changes in the electrical resistance of sensing element 130 in response to changes in the nearby chemical environment, for example, due to the presence of analytes of interest.

In some embodiments, sensing element 130 may include a plurality of particles 10. Particles 10 may be mixed with a carrier solvent and printed/deposited in order to form sensing element 130. The carrier solvent may be evaporated prior to the use of sensing element 130.

Reference is now made to FIG. 2A which is an illustration of a nanoparticle 10 according to some embodiment of the invention. Nanoparticle 10 may include a conductive core 12 and a plurality of ligands (e.g. organic ligands) 16 bonded to core 12.

In some embodiments, the nanoparticle of the invention is non-uniformly shaped. In some embodiments, a plurality of nanoparticles of the invention is devoid of a defined shape (e.g. the particles have a random shape). In some embodiments, the nanoparticle of the invention is characterized by substantially spherical shape, elliptical shape, and/or a cylindrical shape. In some embodiments, the shape of the nanoparticle is substantially predefined by the shape of the conductive core.

### Core

Conductive core 12 may include any conductive suitable material, for example, a metal (e.g. a metal in an elemental state) and/or any conductive metallic oxide. For example, conductive core 12 may include: one or more transitional metal(s), optionally the transitional metal is substantially in an elemental state within said core. Some nonlimiting examples of transitional metals for conductive core 12 include: Ir, Ir-alloy, IrOx, Ru, Ru-alloy, RuOx Au, Pt, Pd, Ag and further also alloys consisting of Ni, Co, Cu, Al, Au/Ag, Au/Cu, Au/Ag/Cu, Au/Pt, Au/Pd, Au/Ag/Cu/Pd, Pt/Rh, Ni/Co, and Pt/Ni/Fe and any combination thereof. Other conductive metals or metal oxides are well-known in the art.

In some embodiments, each of the nanoparticles of the invention comprises a single conductive core. In some embodiments, each of the nanoparticles of the invention comprises the same conductive core, and the same or different ligand species. In some embodiments, at least a portion of the nanoparticles of the invention have chemically distinct conductive cores and the same or different ligand species.

In some embodiments, the nanoparticles of the invention are characterized by a particle size in a range between 1 and 100 nm, between 1 and 10 nm, between 10 and 50 nm, between 50 and 100 nm, including any range between. In some embodiments, the nanoparticles of the invention are characterized by a particle size in a range between 1 and 5 nm, between 1 and 3 nm, between 3 and 5 nm, between 5 and 7 nm, between 7 and 10 nm, including any range between.

In some embodiments, the term “particle size” refers to average cross section size of the nanoparticles.

### Shell

In some embodiments, ligands 16 are assembled to form a shell on top of core 12. In some embodiments, ligands 16 are selected to make nanoparticle 10 characterized by sensitivity to the analyte of interest (e.g., analyte).

Some nonlimiting examples for optional ligands 16 may include, Amine like Dodecylamine, Diazoniums, Silanes, Carboxylic Acids, Tri-chloro, methoxy, ethoxy, Tri hydroxide, di-chloro, chloro and any combination thereof.

Some additional nonlimiting examples for optional ligands 16 may include thiols (sulfides). Exemplary thiols that can be bonded with the metallic cores include alkylthiols with C3-C24 chains, co-functionalized alkanethiolates, arenethiolate, (3-mercaptopropyl) tri-methyloxysilane, dialkyl disulfides, xanthates, oligonucleotides, polynucleotides, peptides, proteins, enzymes, polysaccharides, and phospholipids.

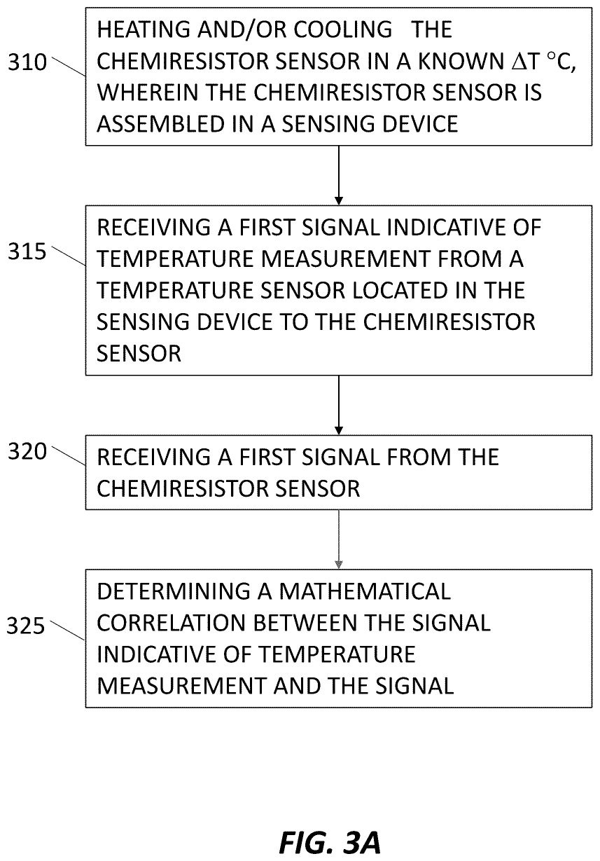

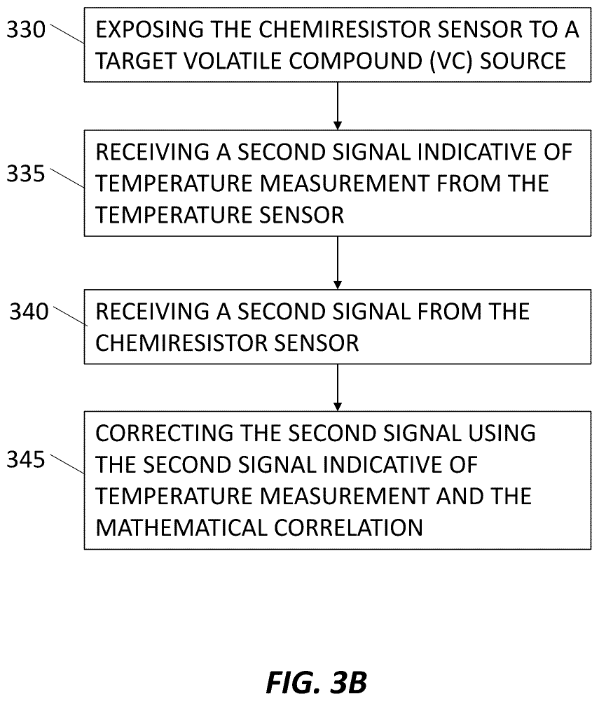

Reference is now made to FIG. 3A, which is a flowchart of a method of an in-situ calibration of a chemiresistor sensor according to some embodiments of the invention. The method of FIG. 3A may be performed by controller 2 of computing device 10 included in sensing system 1000.

In step 310, at least one chemiresistor sensor may be heated and/or cooled in a ΔT° C. For example, one or more chemiresistor sensors 100 of sensing device 50 may be heated and/or cooled using temperature regulation unit 90. In a nonlimiting example, a base temperature for chemiresistor sensors 100 may be determined (e.g., room temperature) and controller 2 may control temperature regulation unit 90 to heat one or more chemiresistor sensors 100 by +1° C. In some embodiments, one or more chemiresistor sensors 100 may be left to naturally cooled down to the base temperature or controllably cooled down by temperature regulation unit 90. In some embodiments, a reverse procedure may be conducted, where temperature regulation unit 90 first cools one or more chemiresistor sensors 100 by +1° C. followed by either natural heating or controlled heating. In some embodiments, temperature regulation unit 90 may either heat one or more chemiresistor sensors 100 or cool one or more chemiresistor sensors 100.

In some embodiments, during the heating and cooling, the chemiresistor sensor is exposed to a known environment, for example, one of: vacuum of at least 0.7 atm, at least 99% N₂, at least 99% He, at least 99% H₂, at least 99% Ar, and a known concentration of a known analyte.

In some embodiments, during the heating and cooling, the chemiresistor sensor is exposed to an analyte of interest, having an unknown concentration.

In step 315, a first temperature signal indicative of temperature measurement may be received from a temperature sensor located in the sensing device to the chemiresistor sensor. For example, the first temperature signal indicative of temperature measurement may be a resistance of a wire attached to chemiresistor sensor 100 or placed elsewhere inside device 50, a voltage of a thermocouple or any other direct or indirect measurement of the temperature. In some embodiments, temperature sensor 80 may measure the temperature during the heating and/or cooling phase of step 310.

In some embodiments, the first temperature signal may be a time dependent signal, for example, as shown in equation 1.

$$T ( t ) = \begin{matrix}{T}_{0} + {u}_{1} t & 0 < t < {t}_{0} \\ {T}_{0} + {u}_{1} {t}_{0} - {u}_{2} ( {t}_{0} - t ) & {t}_{0} < t < {t}_{1}\end{matrix} \qquad ( 1 )$$

Wherein T(t) the temperature as function of time, To the initial temperature, u₁ the heating rate until t₀ and u₂ the cooling rate from t₀ to t₁ (or vice versa), to is the end of heating (or cooling). and t₁ is the end of cooling (or heating). In some embodiments, u₁ is equal to u₂.

In step 320, a first signal may be received from the chemiresistor sensor during the heating/or cooling. In some embodiments, the first signal is one of, a resistance of chemiresistor sensor 100, a capacity of chemiresistor sensor 100, a conductivity of chemiresistor sensor 100, impedance and inductance of chemiresistor sensor 100 and the like. In some embodiments, the heating and/or cooling induces changes in the signal indicative of temperature measurement and the signal received from the chemiresistor sensor. In some embodiments, the first signal may be the baseline value of chemiresistor sensor 100 (the value taken when chemiresistor sensor 100 is not exposed to any analyte).

In step 325, a mathematical correlation may be determined between the first temperature signal and the first signal. In some embodiments, mathematical correlation is selected from, a linear correlation, a polynomial correlation, an exponential correlation and the like.

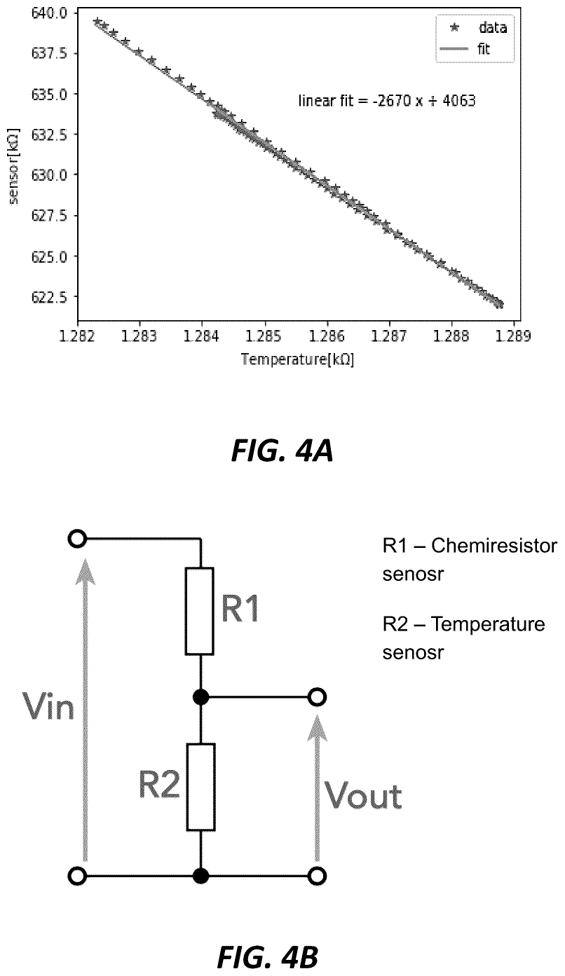

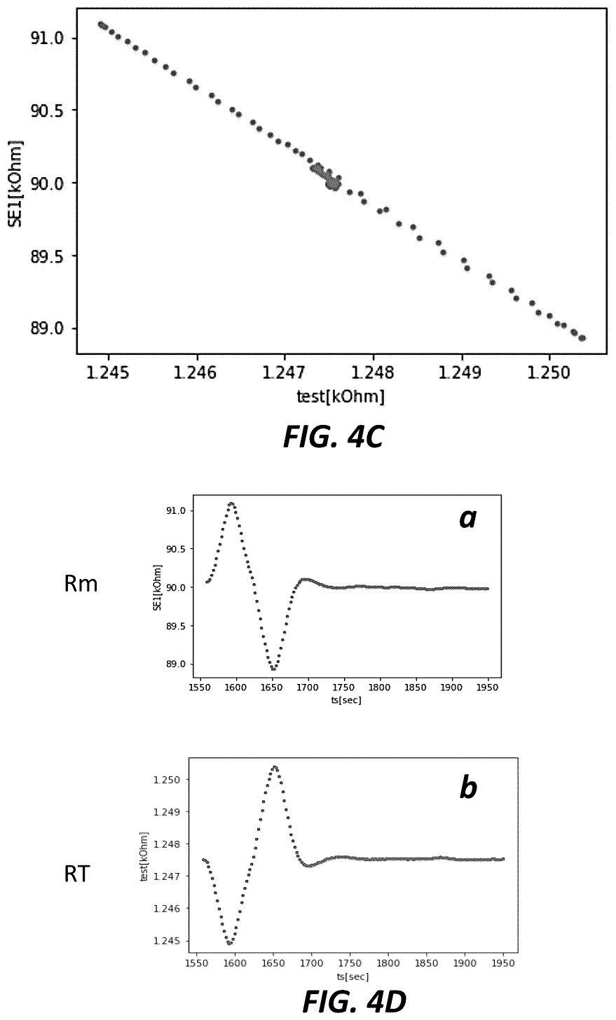

A nonlimiting example, for a linear correlation is demonstrated in FIG. 4A, where the first signal is the resistance of the chemiresistor sensor and the first temperature signal is the resistance R_{T} of a wire attached to the PCB carrying the chemiresistor sensor, or a measurement of the temperature T. A nonlimiting example for the electrical circuit is illustrated in FIG. 4B.

Therefore, the mathematical correlation can be derived from equations 2 or 2*:

$$F ( {R}_{T} ) = {a}_{1} * {R}_{T} + {b}_{1} \qquad ( 2 )$$

$$F ( T ) = {a}_{2} * T + {b}_{2} \qquad ( {2}^{*} )$$

Where R_{T} is the measured first signal when the signal is resistant and T is the measured first signal when the signal is a direct measurement of the temperature, a₁, a₂, b₁ and b₂ are constants taken, for example, from a graph similar to the graph in FIG. 4A.

In the nonlimiting example of FIG. 4A the measurements were taken under a known atmosphere (e.g., clean N₂) when sensor 100 was not exposed to any analyte. Therefore, the measured signals are the baseline signals R₀. In order to calculate constants a₁ and b₁ or a₂ and b₂ either heating/or cooling of chemiresistor sensor 100 and temperature sensor 80 is sufficient.

In some embodiments, the baseline value of a sensor like chemiresistor sensor 100 may change in time due to a phenomenon known as “drift”. In other to compensate for such drift another mathematical correlation may be added. One can assume that over a short period of time (e.g., 1-20 minutes) the drift is linear and may follow equation 3. Assuming the first signal is R₀, the drift can be corrected by:

$$R = {R}_{0} + d * t \qquad ( 3 )$$

Therefore, the mathematical correlations must include also the drift constant d. As drift is a time dependent phenomena, the constant d can be extracted from measurements taken in both cooling and heating phases, as discloses in equation 1, using any graph fitting methods.

Accordingly, equations 4 or 4* may replace equations 2 or 2*.

$$F ( {R}_{T} , t ) = {a}_{1} * {R}_{T} + {b}_{1} + {d}_{1} * t \qquad ( 4 )$$

$$F ( T , t ) = {a}_{2} * T + {b}_{2} + {d}_{2} * t \qquad ( {4}^{*} )$$

In some embodiments, the calibration step of finding the mathematical correlations (with or without drift) may be performed while the chemiresistor sensor is exposed to the sample. During the exposure the first signal is defined by the following exponential equation 5.

$$R ( t ) = {R}_{0} + {r}_{0} [ 1 - {e}^{- \frac{t}{τ}} ] \qquad ( 5 )$$

Wherein, R₀ the baseline measurement of the chemiresistor sensor, r₀ is the steady-state response amplitude, and t is the response time of the chemiresistor sensor.

Accordingly, equations 6 or 6* may replace equations 4 or 4*.

$$F ( {R}_{T} , t ) = {a}_{1} * {R}_{T} + {b}_{1} + {d}_{1} * t + {R}_{0} + {r}_{0} [ 1 - {e}^{- \frac{t}{τ}} ] \qquad ( 6 )$$

$$F ( T , t ) = {R}_{M} - {a}_{2} * T + {b}_{2} + {d}_{2} * t + {R}_{0} + {r}_{0} [ 1 - {e}^{- \frac{t}{τ}} ] \qquad ( {6}^{*} )$$

In some embodiments, the drift is optional and may not necessarily be included in equations 6 or 6*.

Reference is now made to FIGS. 4C and 4D which shows graphs of time dependent measurements of sensor 100 and sensor 80 during a calibration period when the sensor is exposed to an analyte. Graph a in FIG. 4D shows the measurements from the temperature sensor (SE1) during heating and cooling phases and graph b in FIG. 4D shows the response of the chemiresistor sensor to the heating and cooling. The graph in FIG. 4C show the correlation between the temperature signal R_{T} and the first signal Rm. As one can see, for each temperature measurement, two first signals were plotted (see the dashed line), one during heating and one during cooling. However, the substantial linear behavior remained, therefore parameters a₁, a₂, b₁ and b₂ and optionally d₁ or d₂, can be extracted from the graph.

The mathematical correlation of step 320 may be used for in situ corrections of measurements from one or more chemiresistor 100.

Reference is now made to FIG. 3B which is a flowchart of a method of an in-situ correction of sensing measurements using the calibration correlation determined by the method of FIG. 3A according to some embodiments of the invention. The method of FIG. 3B may be performed by controller 2 of computing device 10 included in sensing system 1000.

In step 330, the chemiresistor sensor may be exposed to a target analyte source. For example, one or more chemiresistor sensors 100 may be expose an analytic of interest in a gas phase, when sample delivery system 50 may deliver a gas sample (e.g., an exhaled air) to sensing chamber 70 and one or more chemiresistor sensors 100.

In step 335, a second temperature signal indicative of temperature measurement may be received from the temperature sensor. In some embodiments, the second temperature signal may be received from an in-situ temperature sensor 80 located inside sensing device 50 as discussed herein above. The second temperature signal may be a resistance of a wire attached to chemiresistor sensor 100 or placed elsewhere inside device 50, a voltage of a thermocouple or any other direct or indirect measurement of the temperature. In some embodiments, the second temperature signal may be measured by the same temperature sensor 80 used for measuring the first second temperature signal.

In step 340, a second signal may be received from the chemiresistor sensor. In some embodiments, the second signal is one of, a resistance of chemiresistor sensor 100, a capacity of chemiresistor sensor 100, a conductivity of chemiresistor sensor 100, impedance and inductance of chemiresistor sensor 100 and the like.

In step 345, the second signal may be corrected using the second temperature signal and the mathematical correlation. For example, corrected signal R_{C} using any one of equations 2, 2*, 4, 4*, 6, and 6*. The second signal Rₘ may be corrected using equations 7 or 7*

$$Rc = Rm ( t ) - F ( {R}_{T} ) \qquad ( 7 )$$

$$Rc ( t ) = Rm ( t ) - F ( {R}_{T} , t )$$

$$Rc = Rm ( t ) - F ( T ) \qquad ( {7}^{*} )$$

$$Rc ( t ) = Rm ( t ) - F ( T , t )$$

Wherein R_{C} is the corrected measured signal from the chemiresistor sensor. R_{C}(t) is a time-dependent corrected measured signal from the chemiresistor sensor when a drift and/or a calibration done using an analyte is taking place.

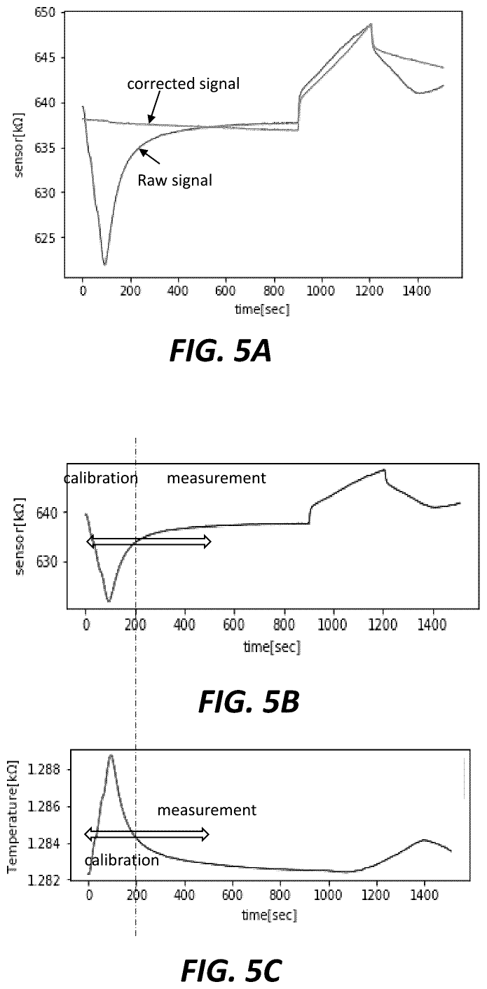

Some nonlimiting examples for correcting measurements are shown in the graph of FIGS. 5A, 5B, and 5C. FIG. 5A shows a raw second signal as received from sensing device 50 and a corrected signal after being corrected using a linear metamathematical correlation.

In some embodiments, each sensor may first undergo a calibration stage, following by a measurement stage, as illustrated in FIG. 5A which shows first and second signals received from one or more chemiresistor sensors 100 and FIG. 5B which show the first and second temperature signal received from temperature sensor 80. The measurements were taken as a function of time during both the heating and cooling stages in order to eliminate a drift. The sensing signals in the graphs of FIGS. 5A, 5B, and 5C were corrected using equation 7.

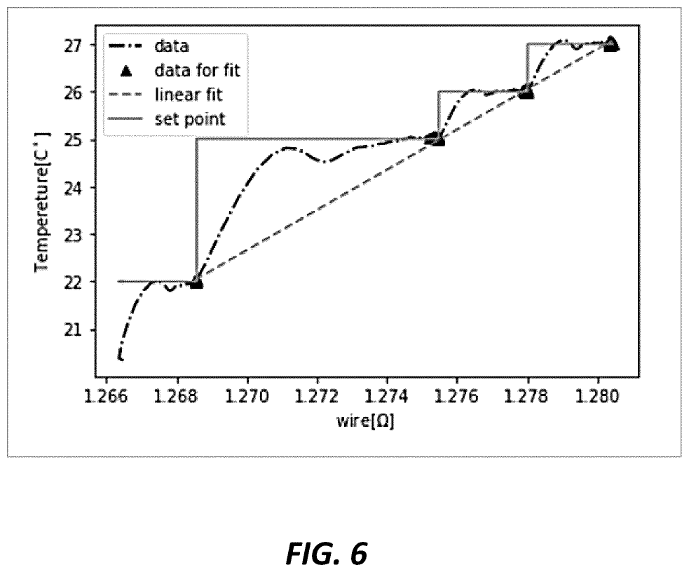

FIG. 6 is a graph showing a nonlimiting calibration process of a wire acting as a temperature sensor, where the resistance is the value indicative of the temperature. The resistance measurements are compared to temperature measurements taken by a thermometer. The temperature of both the wire and the thermometer is elevated in steps determined by the set point (gray line). The doted-dashed line presents the system stabilizing process. When the system is stable both the temperature and the resistance measurements (triangular) points, are fitted into a linear line (dashed line). The parameters of the line provides the calibration function between the resistance and the temperature.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of an in-situ calibration of a chemiresistor sensor, comprising:
heating and/or cooling at least one chemiresistor sensor in a ΔT° C., wherein the at least one chemiresistor sensor is assembled in a sensing device;
receiving a first temperature signal indicative of temperature measurement from a temperature sensor located in the sensing device to the chemiresistor sensor;
receiving a first signal from the chemiresistor sensor; and
determining a mathematical correlation between the first temperature signal and the first signal,
wherein the heating and/or cooling induces changes in the signal indicative of temperature measurement and the signal received from the chemiresistor sensor.

2. The method of claim 1, wherein during the heating and cooling, the chemiresistor sensor is exposed to a known environment.

3. The method of claim 1, further comprising:
exposing the chemiresistor sensor to a target analyte source;
receiving a second temperature signal indicative of temperature measurement from the temperature sensor;
receiving a second signal from the chemiresistor sensor; and
correcting the second signal using the second temperature signal and the mathematical correlation.

4. The method of claim 1, wherein the mathematical correlation is selected from, a linear correlation, a polynomial correlation, and an exponential correlation.

5. The method of claim 1, wherein the temperature sensor is selected from: a conductive wire attached to the chemiresistor sensor, a thermocouple attached to the chemiresistor sensor, and a thermometer located anywhere inside the sensing device.

6. The method of claim 1, wherein the first signal is one of, a resistance of the chemiresistor sensor, a capacity of the chemiresistor sensor, a conductivity of the chemiresistor sensor, impedance and inductance of the chemiresistor sensor.

7. The method of claim 2, wherein the known environment comprising one of:
vacuum of at least 0.7 atm, at least 99% N₂, at least 99% He, at least 99% H₂, at least 99% Ar, and a known concentration of a known analyte.

8. The method of claim 1, wherein the heating and/or cooling is conducted from a predetermined base temperature.

9. A sensing system with an in-situ temperature calibration, comprising:
a sensing device comprising:
a sensing chamber;
a sample delivery system configured to deliver analyte sample into the sensing chamber;
a chemiresistor sensor located inside the sensing chamber; and
a temperature sensor located inside the sensing device; and
a controller configured to:
heat and/or cool the chemiresistor sensor to a ΔT° C.;
receive a first signal indicative of temperature measurement from the temperature sensor;
receive a first signal from the chemiresistor sensor; and
determine a mathematical correlation between the signal indicative of temperature measurement and the signal,
wherein the heating and/or cooling induces changes in the signal indicative of temperature measurement and the signal received from the chemiresistor sensor,

10. The system of claim 9, wherein during the heating and cooling, the chemiresistor sensor is exposed to a known environment.

11. The system of claim 9, wherein the controller is further configured to:
expose the chemiresistor sensor to a target analyte source;
receive a second signal indicative of temperature measurement from the temperature sensor;
receive a second signal from the chemiresistor sensor; and
correct the second signal using the second signal indicative of temperature measurement and the mathematical correlation.

12. The system of claim 9, wherein the mathematical correlation is selected from, a linear correlation, a polynomial correlation, and an exponential correlation.

13. The system of claim 9, wherein the temperature sensor is selected from: a conductive wire attached to the chemiresistor sensor, a thermocouple attached to the chemiresistor sensor, and a thermometer located anywhere inside the sensing device.

14. The system of claim 9, wherein the first signal is one of, a resistance of the chemiresistor sensor, a capacity of the chemiresistor sensor, a conductivity of the chemiresistor sensor, impedance and inductance of the chemiresistor sensor.

15. The system of claim 9, wherein the known environment comprising one of:
vacuum of at least 0.7 atm, at least 99% N₂, at least 99% He, at least 99% H₂, at least 99% Ar, and a known concentration of a known analyte.

16. The system of claim 9, wherein the heating and/or cooling is conducted from a predetermined base temperature.
